(19) United States
(12) Patent Application Publication
(10) Pub. No.: US 2026/0091731 A1
(43) Pub. Date: Apr. 2, 2026

(54) LADDER FOR WORK MACHINE

(71) Applicant: Caterpillar Inc., Peoria, IL (US)

(72) Inventors: Shamshad S. Ahmed, Oro-Valley, AZ (US); Ankush Sharma, Jalandhar (IN)

(73) Assignee: Caterpillar Inc., Peoria, IL (US)

(21) Appl. No.: 18/903,264

(22) Filed: Oct. 1, 2024

(51) Int. Cl. B60R 3/00

(52) U.S. Cl. CPC B60R 3/00

(57) ABSTRACT

A ladder for a work machine defines a length between a first end and a second end. The ladder includes a pair of side rails and a number of rungs removably coupled with each of the pair of side rails and extending between the pair of side rails. Each of the pair of side rails includes a side rail portion, a first portion integral with the side rail portion and a second portion defining a free end and a coupling end. The first portion extends orthogonally relative to the side rail portion. The second portion extends at least partially along the length of the ladder and is integrally coupled with the side rail portion at the coupling end. The second portion extends at an oblique angle relative to the side rail portion. The second portion includes a rolled section at the free end of the second portion.

### TECHNICAL FIELD

The present disclosure relates to a work machine, and more particularly, to a ladder for the work machine and a method of manufacturing the ladder for the work machine.

### BACKGROUND

A work machine, such as a mining truck, is often used at various worksites to perform work operations. The work machines are large in size and thus require ladders to access various parts of the work machine. The work machine also includes one or more handrails that are coupled to the ladder. The handrails and the ladder together allow operators or service personnel to board or deboard the work machine.

Conventional ladders include a pair of side rails. The pair of side rails are coupled with a corresponding long tubular structure of the handrail, for example, by welding. The tubular structure of the handrail extends along a substantial length of the ladder, which may increase cost and material associated with the handrail. Overall, such a design of the ladder may be costly, may be difficult to manufacture, and may be heavy, which is not desirable.

WO2017115611 discloses a method for manufacturing an access step device, and an access step device. In order to reduce the number of parts, an access step device comprises a pair of vertically extending facing supports and steps provided between the supports. A method for manufacturing the access step device has: a support forming step for forming the pair of supports by bending both ends of a single metal sheet; a cutting step for forming, in the metal sheet, cuts for forming the steps; and a step forming step for forming the steps by bending the tread plate sections of the steps formed by the cuts formed by the cutting step.

### SUMMARY OF THE DISCLOSURE

In an aspect of the present disclosure, a ladder for a work machine is provided. The ladder defines a first end, a second end, and a length between the first end and the second end. The ladder includes a pair of side rails adapted to be removably coupled with a frame of the work machine. The pair of side rails extend along the length of the ladder and are spaced apart from each other in a direction that is orthogonal to the length of the ladder. Each of the pair of side rails includes a side rail portion extending from the first end of the ladder to the second end of the ladder. Each of the pair of side rails also includes a first portion integral with the side rail portion. The first portion extends orthogonally relative to the side rail portion. The first portion extends at least partially along the length of the ladder from the first end of the ladder towards the second end of the ladder. The first portion is adapted to removably couple the ladder with the frame of the work machine proximal to the first end of the ladder. Each of the pair of side rails further includes a second portion defining a free end and a coupling end. The second portion extends at least partially along the length of the ladder from the first end of the ladder towards the second end of the ladder and is integrally coupled with the side rail portion at the coupling end of the second portion. The second portion extends at an oblique angle relative to the side rail portion. The second portion includes a rolled section at the free end of the second portion. The ladder also includes a plurality of rungs removably coupled with each of the pair of side rails and extending between the pair of side rails.

In another aspect of the present disclosure, a work machine is provided. The work machine includes a frame. The work machine also includes a ladder removably coupled with the frame. The ladder defines a first end, a second end, and a length between the first end and the second end. The ladder includes a pair of side rails adapted to be removably coupled with a frame of the work machine. The pair of side rails extend along the length of the ladder and are spaced apart from each other in a direction that is orthogonal to the length of the ladder. Each of the pair of side rails includes a side rail portion extending from the first end of the ladder to the second end of the ladder. Each of the pair of side rails also includes a first portion integral with the side rail portion. The first portion extends orthogonally relative to the side rail portion. The first portion extends at least partially along the length of the ladder from the first end of the ladder towards the second end of the ladder. The first portion is adapted to removably couple the ladder with the frame of the work machine proximal to the first end of the ladder. Each of the pair of side rails further includes a second portion defining a free end and a coupling end. The second portion extends at least partially along the length of the ladder from the first end of the ladder towards the second end of the ladder and is integrally coupled with the side rail portion at the coupling end of the second portion. The second portion extends at an oblique angle relative to the side rail portion. The second portion includes a rolled section at the free end of the second portion. The ladder also includes a plurality of rungs removably coupled with each of the pair of side rails and extending between the pair of side rails.

In yet another aspect of the present disclosure, a method of manufacturing a ladder for a work machine is provided. The method includes providing a first piece of material and a second piece of material. The method also includes forming a first side rail portion of a first side rail of the ladder from the first piece of material. The first side rail extends along a length of the ladder from a first end of the ladder to a second end of the ladder. The method further includes bending the first piece of material to form a first portion of the first side rail such that the first portion extends orthogonally relative to the first side rail portion. The first portion extends at least partially along the length of the ladder from the first end of the ladder towards the second end of the ladder. The first portion of the first side rail is adapted to removably couple the ladder with a frame of the work machine proximal to the first end of the ladder. The method includes bending the first piece of material to form a second portion of the first side rail such that the second portion extends at an oblique angle relative to the first side rail portion. The second portion defines a free end and a coupling end. The second portion extends at least partially along the length of the ladder from the first end of the ladder towards the second end of the ladder. The method also includes bending, at least partially, the second portion of the first side rail proximal to the free end to form a rolled section at the free end of the second portion. The method further includes forming a second side rail portion of a second side rail of the ladder from the second piece of material. The second side rail extends along the length of the ladder and is spaced apart from the first side rail in a direction that is orthogonal to the length of the ladder. The second side rail portion extends from the first end of the ladder to the second end of the ladder. The method includes bending the second piece of material to form a first portion of the second side rail such that the first portion extends in an orthogonally relative to the second side rail portion. The first portion extends at least partially along the length of the ladder from the first end of the ladder towards the second end of the ladder. The first portion of the second side rail is adapted to removably couple the ladder with the frame of the work machine proximal to the first end of the ladder. The method also includes bending the second piece of material to form a second portion of the second side rail such that the second portion extends at an oblique angle relative to the second side rail portion. The second portion defines a free end and a coupling end. The second portion extends at least partially along the length of the ladder from the first end of the ladder towards the second end of the ladder. The method further includes bending, at least partially, the second portion of the second side rail proximal to the free end to form a rolled section at the free end of the second portion. The method includes removably coupling a plurality of rungs with each of the first side rail and the second side rail such that the plurality of rungs extend between the first side rail and the second side rail.

Other features and aspects of this disclosure will be apparent from the following description and the accompanying drawings.

### BRIEF DESCRIPTION OF THE DRAWINGS

FIG. 1 is a schematic perspective view of an exemplary work machine;

FIG. 2 is a schematic perspective view of a portion of the work machine of FIG. 1, according to an example of the present disclosure;

FIG. 3A is a schematic perspective view of a ladder for the work machine of FIG. 1.

FIG. 3B is a schematic top view of the ladder of FIG. 3A;

FIG. 4 is a schematic perspective view of a mounting member associated with the ladder of FIG. 3A;

FIG. 5A is a schematic perspective view of a portion X of the ladder of FIG. 3A;

FIG. 5B is a schematic perspective view of a portion of the ladder of FIG. 3A;

FIG. 6 is a schematic perspective view of the ladder coupled with a handrail of the work machine of FIG. 1;

FIG. 7 is a schematic perspective view illustrating a service area of the work machine of FIG. 1, according to another example of the present disclosure; and

FIG. 8 is a flowchart of a method of manufacturing the ladder for the work machine, according to another example of the present disclosure.

### DETAILED DESCRIPTION

Wherever possible, the same reference numbers will be used throughout the drawings to refer to the same or like parts.

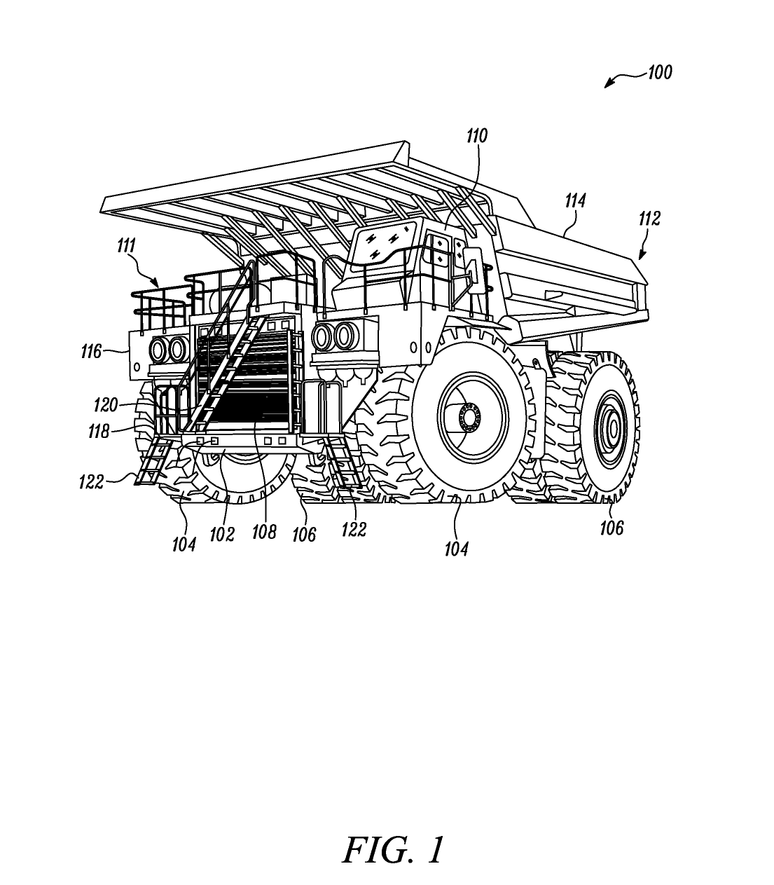

Referring to FIG. 1, a schematic perspective view of a work machine 100 is illustrated. The work machine 100 is embodied as a mining truck that may be used to move a payload, such as, asphalt, debris, dirt, snow, feed, gravel, logs, raw minerals, recycled material, rock, sand, woodchips, etc. from one location to another location. Alternatively, the work machine 100 may be any haul truck, an excavator, a dozer, a wheel loader, a track-type tractor, a motor grader, etc. that may be used for various purposes, such as digging, construction, landscaping, and the like in various industries.

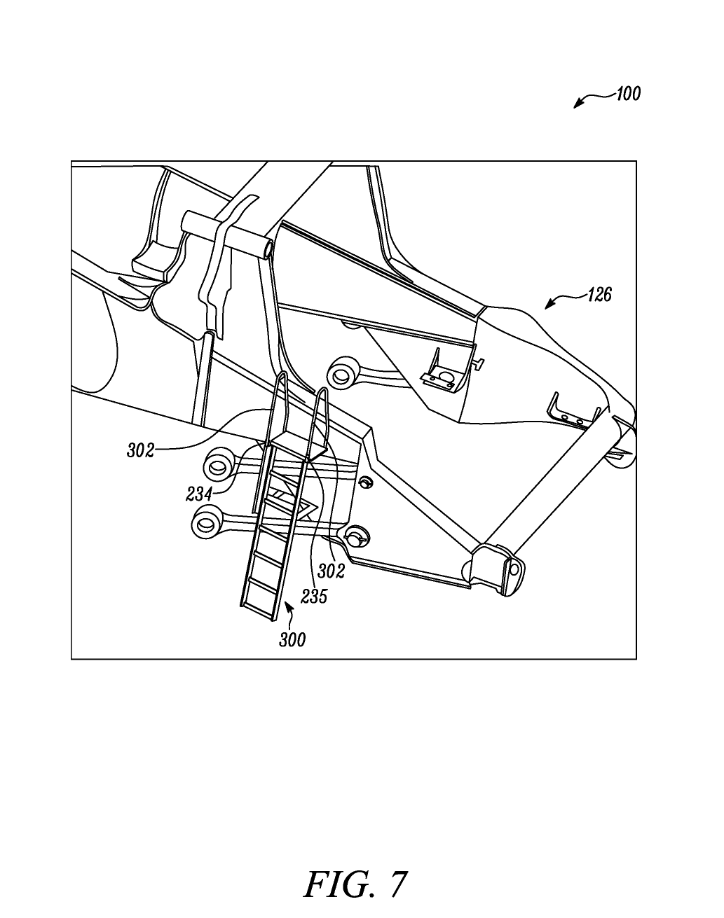

The work machine 100 includes a frame 102. The frame 102 supports a pair of front wheels 104 and a pair of rear wheels 106 of the work machine 100. The work machine 100 also includes an enclosure 108. The enclosure 108 may house a power source (not shown), such as, an engine (for e.g., an internal combustion engine), a battery system, motors, a fuel cell, and the like to provide power to various components of the work machine 100 for operational and mobility requirements. The work machine 100 includes a service area 126 (shown in FIG. 7). An operator may access the power source of the work machine 100 through the service area 126.

The work machine 100 further includes a dump body 112. The dump body 112 includes a box portion 114. The box portion 114 of the dump body 112 may hold the payload. The work machine 100 includes an upper deck 116 and a lower deck 118. Each of the upper deck 116 and the lower deck 118 are supported by the frame 102.

The work machine 100 also includes an operator station 110 mounted to the frame 102. The operator station 110 may include one or more controls (not shown) that may enable the operator to control the work machine 100. The operator may be seated within the operator station 110 to perform work operations.

The work machine 100 also includes an operator platform 111. Particularly, the operator platform 111 is defined on the upper deck 116 of the work machine 100. The operator may stand at the operator platform 111 to view ongoing work operations.

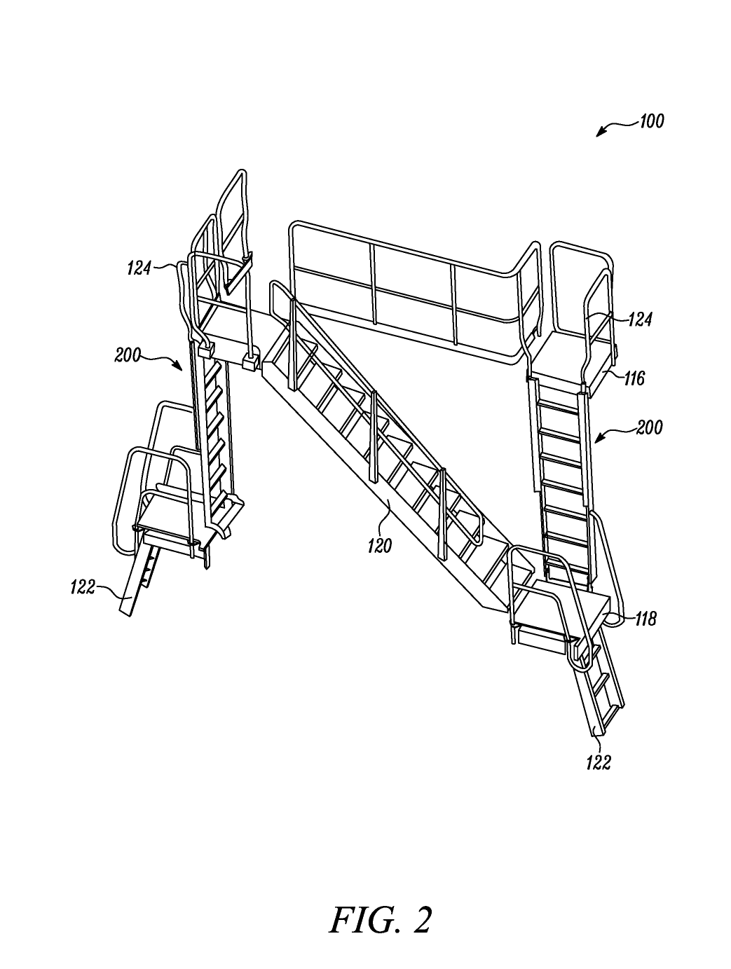

Referring to FIG. 2, a schematic perspective view of a portion of the work machine 100 is illustrated. With reference to FIGS. 1 and 2, the work machine 100 includes a ladder 120. The ladder 120 connects the upper deck 116 and the lower deck 118. The ladder 120 allows the operator to climb up or down between the upper deck 116 and the lower deck 118 thereby providing access to the operator station 110 (see FIG. 1) and/or the operator platform 111 (see FIG. 1). The ladder 120 may be a power access stairway.

The work machine 100 also includes a ladder 122. In some examples, the ladder 122 may allow the operator to climb up or down from the work machine 100. Specifically, the ladder 122 allows the operator to ascend/descend between the lower deck 118 and the ground surface. In the illustrated example of FIG. 2, the work machine 100 includes two ladders 122 disposed on either side of the lower deck 118. In other examples, the work machine 100 may include a single ladder 122.

The work machine 100 further includes a ladder 200 removably coupled with the frame 102 (see FIG. 1). Specifically, the ladder 200 connects the upper deck 116 and the lower deck 118. The ladder 200 extends vertically between the upper deck 116 and the lower deck 118. The ladder 200 allows the operator to climb up or down between the upper deck 116 and the lower deck 118. The ladder 200 allows access to the operator station 110 of the work machine 100. The ladder 200 may also allow access to the operator platform 111 of the work machine 100. In the illustrated example of FIG. 2, the work machine 100 includes two ladders 200 disposed on either side of the work machine 100. In other examples, the work machine 100 may include a single ladder 200. The ladder 200 is made of sheet metal. Specifically, the ladder 200 is fabricated from the sheet metal. In other examples, any other material that may allow easy fabrication of the ladder 200 may be contemplated, without limiting the scope of the present disclosure.

The work machine 100 includes a handrail 124 fixedly coupled to the upper deck 116. The handrail 124 may assist the operator to deboard or board the operator platform 111 and/or the operator station 110 of the work machine 100. In the illustrated example of FIG. 2, the work machine 100 includes two handrails 124 that are removably coupled with a corresponding ladder 200.

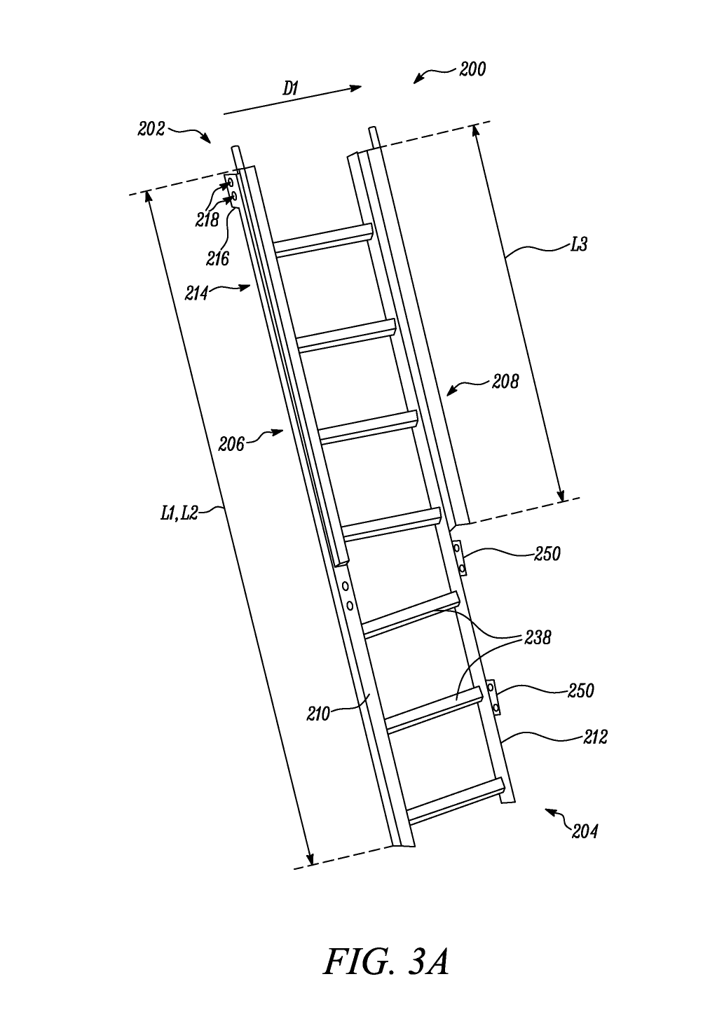

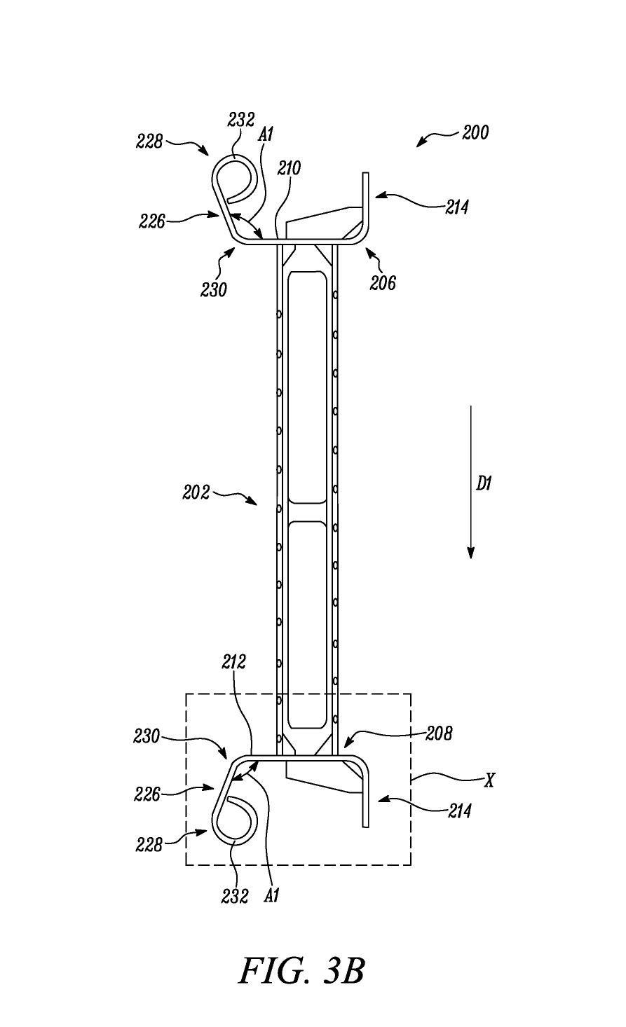

Referring to FIG. 3A, a schematic perspective view of the ladder 200 for the work machine 100 of FIG. 1 is illustrated. FIG. 3B is a schematic top view of the ladder 200 of FIG. 3A. With reference to FIGS. 3A and 3B, the ladder 200 defines a first end 202. The ladder 200 also defines a second end 204. The second end 204 is opposite to the first end 202. The ladder 200 further defines a length L1 between the first end 202 and the second end 204.

The ladder 200 includes a pair of side rails 206, 208. The pair of side rails 206, 208 is removably coupled with the frame 102 (see FIG. 1) of the work machine 100. The pair of side rails 206, 208 extend along the length L1 of the ladder 200 and are spaced apart from each other in a direction D1 that is orthogonal to the length L1 of the ladder 200.

Specifically, the pair of side rails 206, 208 includes a first side rail 206 and a second side rail 208. It should be noted that the first side rail 206 and the second side rail 208 are substantially similar to each other. The first side rail 206 is hereinafter interchangeably referred to as the side rail 206. Further, the second side rail 208 is hereinafter interchangeably referred to as the side rail 208.

Each of the pair of side rails 206, 208 includes a side rail portion 210, 212 extending from the first end 202 of the ladder 200 to the second end 204 of the ladder 200. Particularly, the first side rail 206 includes a first side rail portion 210 and the second side rail 208 includes a second side rail portion 212. The first side rail portion 210 is hereinafter interchangeably referred to as the side rail portion 210. The second side rail portion 212 is hereinafter interchangeably referred to as the side rail portion 212. The ladder 200 further includes one or more mounting brackets 250 that couple the ladder 200 with the frame 102 of the work machine 100. The mounting brackets 250 are coupled with the second side rail portion 212 herein. Alternatively, the mounting brackets 250 may be coupled with the first side rail portion 210. The ladder 200 includes two mounting brackets 250. However, the ladder 200 may include any number of mounting brackets 250 as per requirements.

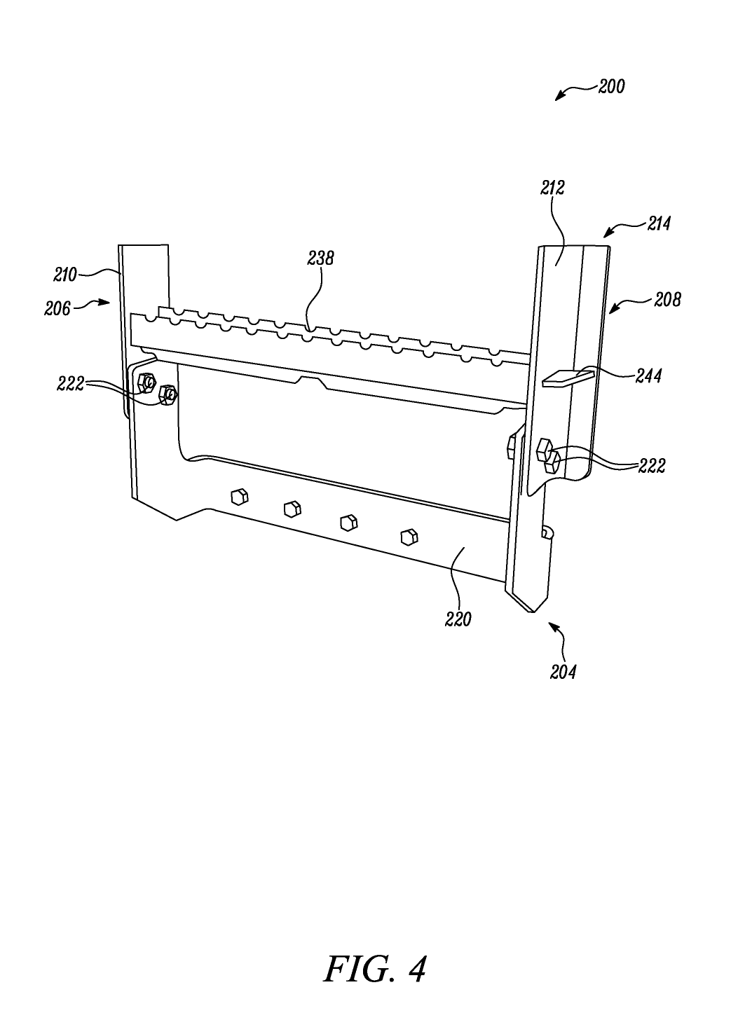

Referring to FIG. 4, the ladder 200 further includes a mounting member 220. The mounting member 220 removably couples the ladder 200 with the frame 102 (see FIG. 1) of the work machine 100 proximal to the second end 204 of the ladder 200. Specifically, the mounting member 220 removably couples the ladder 200 with the lower deck 118 (see FIG. 1) of the frame 102 of the work machine 100. The ladder 200 further includes a number of gussets 244. Specifically, in the illustrated example of FIG. 4, the ladder 200 includes two gussets 244 (only one of which is visible in FIG. 4) that are disposed on each of the first and second side rail portions 210, 212 proximal to the second end 204 of the ladder 200. However, the ladder 200 may include any number of gussets 244 based on application attributes.

The mounting member 220 is removably coupled with each of the pair of side rails 206, 208 and the frame 102 of the work machine 100. Particularly, the mounting member 220 is removably coupled with each of the first side rail portion 210 and the second side rail portion 212 of the first and second side rails 206, 208 respectively via one or more fastening means 222. In some examples, the one or more fastening means 222 may include a bolt, a screw, a rivet, or the like. In the illustrated example of FIG. 4, the mounting member 220 is removably coupled with each of the first side rail portion 210 and the second side rail portion 212 via two fastening means 222. In other examples, the mounting member 220 may be removably coupled with each of the first side rail portion 210 and the second side rail portion 212 via any number of fastening means 222 based on application attributes.

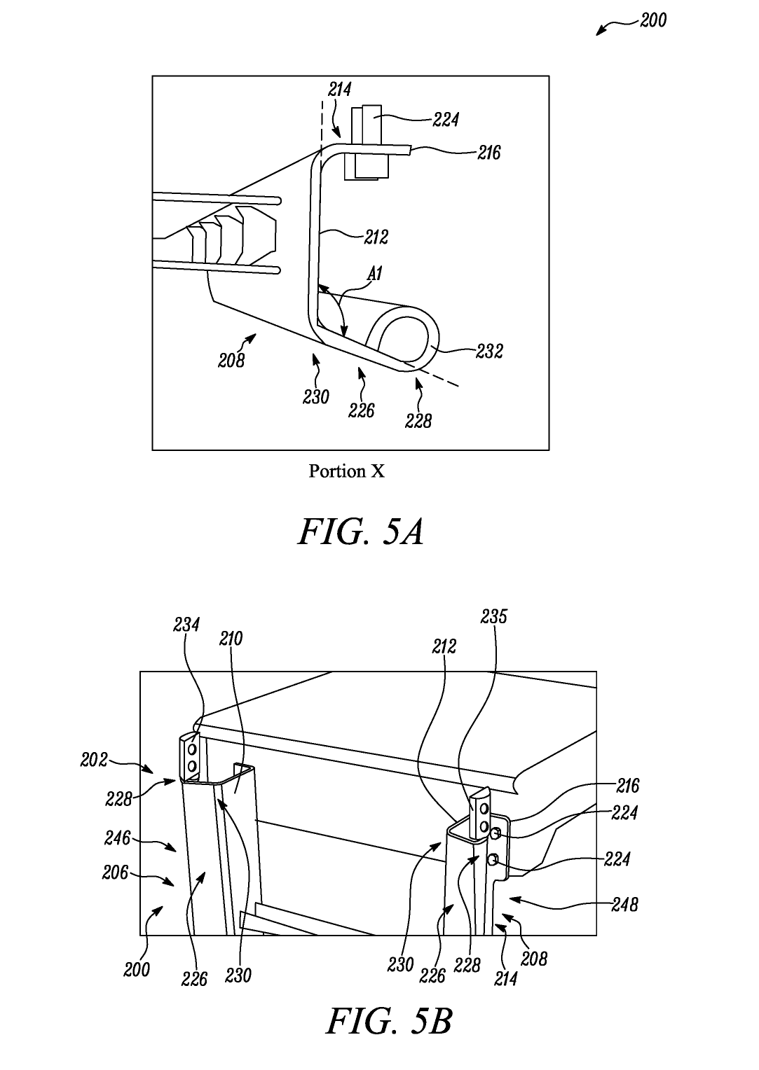

FIG. 5A is a schematic perspective view of a portion X (as shown in FIG. 3B) of the ladder 200. FIG. 5B is a schematic perspective view of a portion of the ladder 200 of FIG. 3A. With reference to FIGS. 5A and 5B, each of the pair of side rails 206, 208 also includes a first portion 214 integral with the side rail portion 210, 212. The first portion 214 extends orthogonally relative to the side rail portion 210, 212. Specifically, the first side rail 206 includes the first portion 214 integral with the first side rail portion 210 that extends orthogonally relative to the first side rail portion 210. The second side rail 208 includes the first portion 214 integral with the second side rail portion 212 that extends orthogonally relative to the second side rail portion 212. It should be noted that the details of the first portion 214 provided hereinafter are equally applicable to each of the first side rail 206 and the second side rail 208.

The first portion 214 extends at least partially along the length L1 (see FIG. 3A) of the ladder 200 from the first end 202 of the ladder 200 towards the second end 204 of the ladder 200. In the illustrated example of FIGS. 5A and 5B, the first portion 214 extends fully from the first end 202 to the second end 204. The first portion 214 removably couples the ladder 200 with the frame 102 (see FIG. 1) of the work machine 100 proximal to the first end 202 of the ladder 200. Specifically, the first portion 214 removably couples the ladder 200 with the upper deck 116 (see FIG. 1) of the frame 102 of the work machine 100.

The first portion 214 includes a mounting plate 216 that is removably coupled with the frame 102 of the work machine 100. The mounting plate 216 defines one or more through-holes 218 (shown in FIG. 3A). In the illustrated example of FIGS. 5A and 5B, the mounting plate 216 defines two through-holes 218. In other examples, the mounting plate 216 may define any number of through-holes 218 based on application attributes. Each through-hole 218 receives a corresponding fastening member 224 to removably couple the first portion 214 of the respective first and second side rails 206, 208 with the upper deck 116 of the frame 102 of the work machine 100.

Each of the pair of side rails 206, 208 further includes a second portion 226. Specifically, each of the first side rail 206 and the second side rail 208 includes the second portion 226. It should be noted that the details of the second portion 226 provided hereinafter are equally applicable to each of the first side rail 206 and the second side rail 208.

The second portion 226 defines a free end 228 and a coupling end 230. The second portion 226 extends at least partially along the length L1 of the ladder 200 from the first end 202 of the ladder 200 towards the second end 204 of the ladder 200. Specifically, the second portion 226 extends along approximately half of the length L1 of the ladder 200 from the first end 202 towards the second end 204 of the ladder 200. The second portion 226 is integrally coupled with the side rail portion 210, 212 at the coupling end 230 of the second portion 226. In other words, the second portion 226 of each of the first side rail 206 and the second side rail 208 is integrally coupled with the first side rail portion 210 and the second side rail portion 212 respectively at the coupling end 230 of the second portion 226. Further, a length L2 (see FIG. 3A) of the first portion 214 is substantially similar to the length L1 of the ladder 200. Further, the length L2 is greater than a length L3 (see FIG. 3A) of the second portion 226.

The second portion 226 extends at an oblique angle A1 relative to the side rail portion 210, 212. Specifically, the second portion 226 of the first side rail 206 extends at the oblique angle A1 relative to the first side rail portion 210. The second portion 226 of the second side rail 208 extends at the oblique angle A1 relative to the second side rail portion 212. In some examples, the oblique angle A1 may be in a range of 90 degrees to 180 degrees. The second portion 226 includes a rolled section 232 at the free end 228 of the second portion 226.

It should be noted that the first side rail 206, the first portion 214 of the first side rail 206, and the second portion 226 of the first side rail 206 are integral with each other and made from a single, first piece of material 246. Moreover, the second side rail 208, the first portion 214 of the second side rail 208, and the second portion 226 of the second side rail 208 are integral with each other and made from a single, second piece of material 248.

The ladder 200 further includes a pair of connectors 234, 235. Specifically, the pair of connectors 234, 235 include a first connector 234 and a second connector 235. The rolled section 232 of the second portion 226 of a corresponding side rail 206, 208 at least partially receives a corresponding connector 234, 235 from the pair of connectors 234, 235. Particularly, the rolled section 232 of the second portion 226 of the first side rail 206 at least partially receives the first connector 234 and the rolled section 232 of the second portion 226 of the second side rail 208 at least partially receives the second connector 235. In some examples, the pair of connectors 234, 235 may be welded with a corresponding rolled section 232 of the pair of side rails 206, 208. Alternatively, the pair of connectors 234, 235 may be coupled with a corresponding rolled section 232 of the pair of side rails 206, 208 via one or more fastening means (not shown herein).

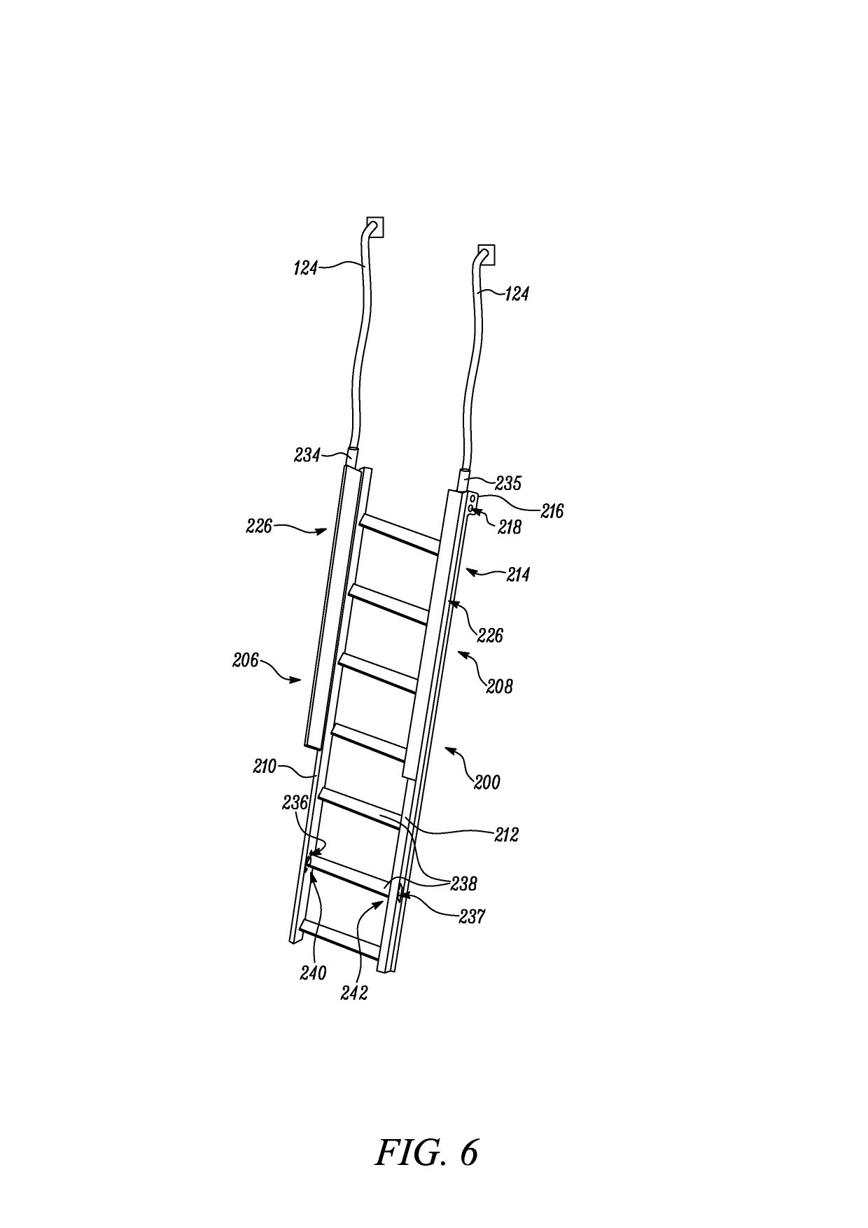

With reference to FIG. 6, each connector 234, 235 from the pair of connectors 234, 235 removably couples the ladder 200 with a corresponding handrail 124 of the work machine 100. In some examples, each connector 234, 235 is removably coupled with the corresponding handrail 124 via one or more fastening means (not shown). In some examples, the fastening means may include a bolt, a screw, a rivet, or the like.

Further, the side rail portion 210, 212 of each of the pair of side rails 206, 208 defines a number of slots 236, 237. Specifically, the number of slots 236, 237 includes a first slot 236 defined in the first side rail 206 and a second slot 237 defined in the second side rail 208.

The ladder 200 further includes a number of rungs 238. The number of rungs 238 are removably coupled with each of the pair of side rails 206, 208. The number of rungs 238 extend between the pair of side rails 206, 208. Specifically, each slot 236, 237 at least partially receives a corresponding rung 238 from the number of rungs 238 to removably couple the corresponding rung 238 with the side rail portions 210, 212. Particularly, one end 240 of the corresponding rung 238 from the number of rungs 238 is at least partially received within the first slot 236 of the first side rail portion 210 to removably couple the corresponding rung 238 with the first side rail portion 210 of the first side rail 206. Further, an opposing end 242 of the corresponding rung 238 from the number of rungs 238 is at least partially received within the second slot 237 of the second side rail portion 212 to removably couple the corresponding rung 238 with the second side rail portion 212 of the second side rail 206.

Referring to FIG. 7, a schematic perspective view of a portion of the work machine 100 illustrating the service area 126 is shown, according to another example of the present disclosure. The work machine 100 includes a ladder 300 removably coupled with the frame 102 of the work machine 100. The ladder 300 is disposed in the service area 126 to access the power source of the work machine 100. The ladder 300 is substantially similar to the ladder 200 shown in FIGS. 3A to 6 with common components being referred to by the same numerals. The ladder 300 includes the pair of connectors 234, 235 that removably couples the ladder 300 with a corresponding handrail 302 of the work machine 100 to access the power source (not shown) of the work machine 100.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is related to the ladder 200, 300 for the work machine 100. The ladder 200, 300 includes the pair of side rails 206, 208. Each of the pair of side rails 206, 208 includes the first portion 214 and the second portion 226. The first portion 214 facilitates coupling of the ladder 200 with the work machine 100.

The second portion 226 includes the rolled section 232 at the free end 228 of the second portion 226. The second portion 226 facilitates coupling of the ladder 200, 300 with the handrails 124, 302. Specifically, the ladder 200, 300 includes the pair of connectors 234, 235 that are received into a corresponding rolled section 232 of the second portion 226. Each connector 234, 235 removably couples the ladder 200, 300 with the corresponding handrail 124, 302 of the work machine 100. The second portion 226 and the connectors 234, 235 may eliminate need of long tubular structures that are otherwise associated with the handrail 124, 302. In some examples, the second portion 226 and the connectors 234, 235 may eliminate a usage of additional handrails. The ladder 200, 300 and the handrail 124, 302 may together provide a three-point contact to the operator to climb up or down between the upper deck 116 and the lower deck 118 of the work machine 100. Thus, the ladder 200, 300 may meet workplace regulations and may also improve access for the operator to board and/or deboard the work machine 100.

Further, the ladder 200, 300 includes the gussets 244. The gussets 244 may improve durability of the ladder 200, 300. Furthermore, the gussets 244 may act as a reinforcement and may prevent twisting of the ladder 200, 300.

Overall, the ladder 200, 300 may be simple in construction, may be cost-effective, and may be durable. The ladder 200, 300 may be easy to manufacture as the ladder 200, 300 does not require costly/complicated set-ups for manufacturing. Further, the ladder 200, 300 may be retrofitted on existing work machines. Moreover, the ladder 200, 300 may be used on a variety of work machines. Further, the mounting member 220 defined herein has a modular design and the design of the mounting member 220 may be varied based on an application of the ladder 200, 300, which may allow usage of the ladder 200, 300 on multiple work machines. It should be noted that the ladder 200, 300 may be disposed at any location on work machines.

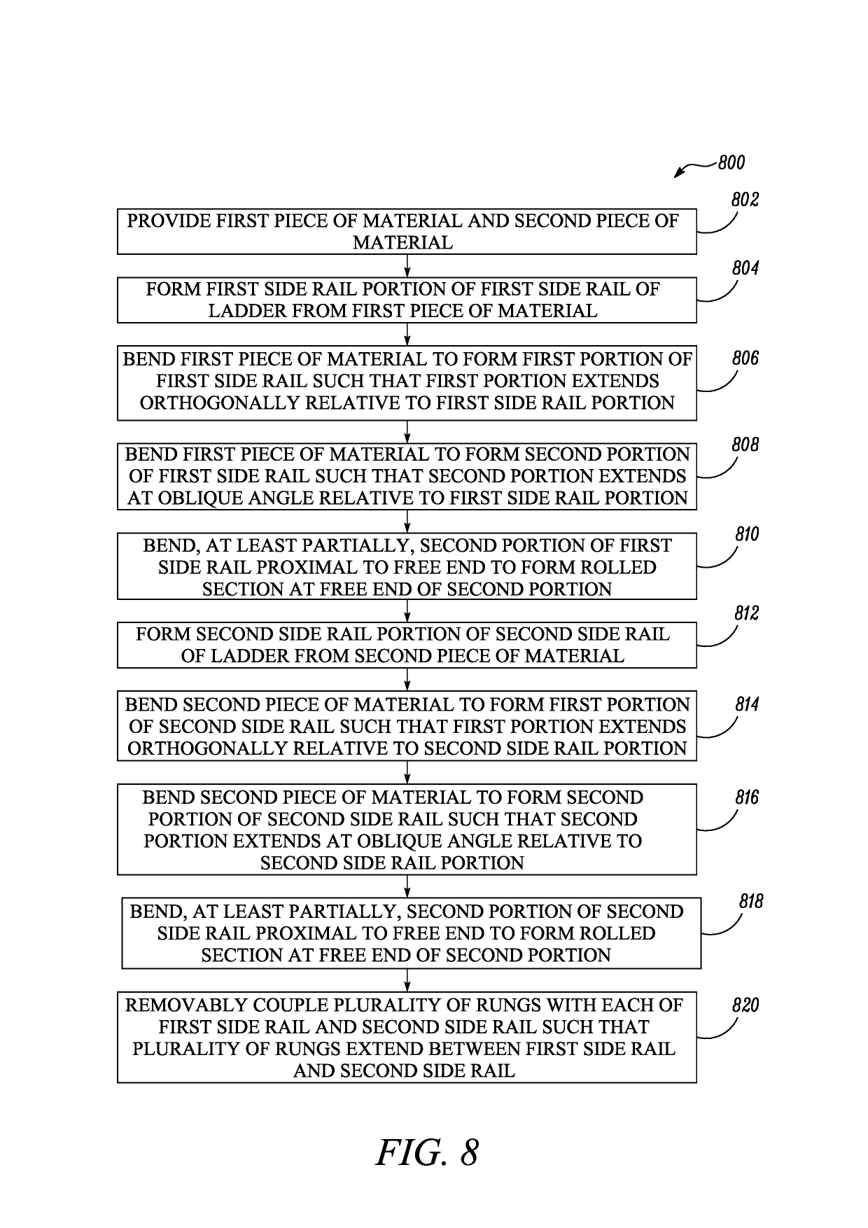

FIG. 8 is a flowchart for a method 800 of manufacturing the ladder 200, 300 for the work machine 100. With reference to FIGS. 1 to 8, at step 802, the first piece of material 246 and the second piece of material 248 are provided. At step 804, the first side rail portion 210 of the first side rail 206 of the ladder 200, 300 is formed from the first piece of material 246. The first side rail 206 extends along the length L1 of the ladder 200, 300 from the first end 202 of the ladder 200, 300 to the second end 204 of the ladder 200, 300.

At step 806, the first piece of material 246 is bent to form the first portion 214 of the first side rail 206 such that the first portion 214 extends orthogonally relative to the first side rail portion 210. The first portion 214 extends at least partially along the length L1 of the ladder 200, 300 from the first end 202 of the ladder 200, 300 towards the second end 204 of the ladder 200, 300. The first portion 214 of the first side rail 206 removably couples the ladder 200, 300 with the frame 102 of the work machine 100 proximal to the first end 202 of the ladder 200, 300.

At step 808, the first piece of material 246 is bent to form the second portion 226 of the first side rail 206 such that the second portion 226 extends at the oblique angle A1 relative to the first side rail portion 210. The second portion 226 defines the free end 228 and the coupling end 230. The second portion 226 extends at least partially along the length L1 of the ladder 200, 300 from the first end 202 of the ladder 200, 300 towards the second end 204 of the ladder 200, 300.

At step 810, the second portion 226 of the first side rail 206 is bent at least partially proximal to the free end 228 to form the rolled section 232 at the free end 228 of the second portion 226.

At step 812, the second side rail portion 212 of the second side rail 208 of the ladder 200, 300 is formed from the second piece of material 248. The second side rail 208 extends along the length L1 of the ladder 200, 300 and is spaced apart from the first side rail 206 in the direction D1 that is orthogonal to the length L1 of the ladder 200, 300. The second side rail portion 212 extends from the first end 202 of the ladder 200, 300 to the second end 204 of the ladder 200, 300.

At step 814, the second piece of material 248 is bent to form the first portion 214 of the second side rail 208 such that the first portion 214 extends orthogonally relative to the second side rail portion 212. The first portion 214 extends at least partially along the length L1 of the ladder 200, 300 from the first end 202 of the ladder 200, 300 towards the second end 204 of the ladder 200, 300. The first portion 214 of the second side rail 208 removably couples the ladder 200, 300 with the frame 102 of the work machine 100 proximal to the first end 202 of the ladder 200, 300.

At step 816, the second piece of material 248 is bent to form the second portion 226 of the second side rail 208 such that the second portion 226 extends at the oblique angle A1 relative to the second side rail portion 212. The second portion 226 defines the free end 228 and the coupling end 230. The second portion 226 extends at least partially along the length L1 of the ladder 200, 300 from the first end 202 of the ladder 200, 300 towards the second end 204 of the ladder 200, 300.

At step 818, the second portion 226 of the second side rail 208 is bent at least partially proximal to the free end 228 to form the rolled section 232 at the free end 228 of the second portion 226. At step 820, the number of rungs 238 are removably coupled with each of the first side rail 206 and the second side rail 208 such that the number of rungs 238 extend between the first side rail 206 and the second side rail 208.

The method 800 further includes a step (not shown) at which the mounting member 220 is removably coupled with each of the first side rail portion 210 and the second side rail portion 212. The mounting member 220 removably couples the ladder 200, 300 with the frame 102 of the work machine 100.

The method 800 further includes a step (not shown) at which the first connector 234 is coupled with the second portion 226 of the first side rail 206 such that the rolled section 232 of the second portion 226 of the first side rail 206 at least partially receives the first connector 234. The first connector 234 removably couples the ladder 200, 300 with the handrail 124, 302 of the work machine 100. The method 800 further includes a step (not shown) at which the second connector 235 is coupled with the second portion 226 of the second side rail 208 such that the rolled section 232 of the second portion 226 of the second side rail 208 at least partially receives the second connector 235. The second connector 235 removably couples the ladder 200, 300 with the handrail 124, 302 of the work machine 100.

The method 800 further includes a step (not shown) at which one end 240 of the corresponding rung 238 from the number of rungs 238 is at least partially received within the first slot 236 of the first side rail portion 210 to removably couple the corresponding rung 238 with the first side rail portion 210. The method 800 further includes a step (not shown) at which the opposing end 242 of the corresponding rung 238 from the number of rungs 238 is at least partially received within the second slot 237 of the second side rail portion 212 to removably couple the corresponding rung 238 with the second side rail portion 212.

It should be noted that the steps 802, 804, 806, 808, 810, 812, 814, 816, 818, 820 of the method 800 may be performed in a sequence that is different from that explained in relation to FIG. 8. Further, various steps 802, 804, 806, 808, 810, 812, 814, 816, 818, 820 can be performed together.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A ladder for a work machine, the ladder defining a first end, a second end, and a length between the first end and the second end, the ladder comprising:
a pair of side rails adapted to be removably coupled with a frame of the work machine, wherein the pair of side rails extend along the length of the ladder and are spaced apart from each other in a direction that is orthogonal to the length of the ladder, each of the pair of side rails including:
a side rail portion extending from the first end of the ladder to the second end of the ladder;
a first portion integral with the side rail portion, wherein the first portion extends orthogonally relative to the side rail portion, wherein the first portion extends at least partially along the length of the ladder from the first end of the ladder towards the second end of the ladder, and wherein the first portion is adapted to removably couple the ladder with the frame of the work machine proximal to the first end of the ladder; and
a second portion defining a free end and a coupling end, wherein the second portion extends at least partially along the length of the ladder from the first end of the ladder towards the second end of the ladder and is integrally coupled with the side rail portion at the coupling end of the second portion, wherein the second portion extends at an oblique angle relative to the side rail portion, and wherein the second portion includes a rolled section at the free end of the second portion; and
a plurality of rungs removably coupled with each of the pair of side rails and extending between the pair of side rails.

2. The ladder of claim 1, wherein the first portion includes a mounting plate that is removably coupled with the frame of the work machine, and wherein the mounting plate defines one or more through-holes.

3. The ladder of claim 2 further comprising a mounting member that is adapted to removably couple the ladder with the frame of the work machine proximal to the second end of the ladder, wherein the mounting member is removably coupled with each of the pair of side rails and the frame of the work machine.

4. The ladder of claim 3, wherein the ladder is adapted to allow access to an operator station of the work machine, wherein the first portion is adapted to removably couple the ladder with an upper deck of the frame of the work machine, and wherein the mounting member is adapted to removably couple the ladder with a lower deck of the frame of the work machine.

5. The ladder of claim 1, wherein the ladder is disposed in a service area to access a power source of the work machine.

6. The ladder of claim 1 further comprising a pair of connectors, wherein the rolled section of the second portion of a corresponding side rail at least partially receives a corresponding connector from the pair of connectors, and wherein each connector from the pair of connectors is adapted to removably couple the ladder with a corresponding handrail of the work machine.

7. The ladder of claim 1, wherein the side rail portion of each of the pair of side rails defines a plurality of slots, and wherein each slot at least partially receives a corresponding rung from the plurality of rungs to removably couple the corresponding rung with the side rail portion.

8. The ladder of claim 1, wherein the ladder is made of sheet metal.

9. A work machine comprising:
a frame; and
a ladder removably coupled with the frame, the ladder defining a first end, a second end, and a length between the first end and the second end, the ladder including:
a pair of side rails adapted to be removably coupled with a frame of the work machine, wherein the pair of side rails extend along the length of the ladder and are spaced apart from each other in a direction that is orthogonal to the length of the ladder, each of the pair of side rails including:
a side rail portion extending from the first end of the ladder to the second end of the ladder;
a first portion integral with the side rail portion, wherein the first portion extends orthogonally relative to the side rail portion, wherein the first portion extends at least partially along the length of the ladder from the first end of the ladder towards the second end of the ladder, and wherein the first portion is adapted to removably couple the ladder with the frame of the work machine proximal to the first end of the ladder; and
a second portion defining a free end and a coupling end, wherein the second portion extends at least partially along the length of the ladder from the first end of the ladder towards the second end of the ladder and is integrally coupled with the side rail portion at the coupling end of the second portion, wherein the second portion extends at an oblique angle relative to the side rail portion, and wherein the second portion includes a rolled section at the free end of the second portion; and
a plurality of rungs removably coupled with each of the pair of side rails and extending between the pair of side rails.

10. The work machine of claim 9, wherein the first portion includes a mounting plate that is removably coupled with the frame of the work machine, and wherein the mounting plate defines one or more through-holes.

11. The work machine of claim 10, wherein the ladder further includes a mounting member that is adapted to removably couple the ladder with the frame of the work machine proximal to the second end of the ladder, and wherein the mounting member is removably coupled with each of the pair of side rails and the frame of the work machine.

12. The work machine of claim 11, wherein the ladder is adapted to allow access to an operator station of the work machine, wherein the first portion is adapted to removably couple the ladder with an upper deck of the frame of the work machine, and wherein the mounting member is adapted to removably couple the ladder with a lower deck of the frame of the work machine.

13. The work machine of claim 9, wherein the ladder is disposed in a service area to access a power source of the work machine.

14. The work machine of claim 9, wherein the ladder further includes a pair of connectors, wherein the rolled section of the second portion of a corresponding side rail at least partially receives a corresponding connector from the pair of connectors, and wherein the pair of connectors are adapted to removably couple the ladder with a corresponding handrail of the work machine.

15. The work machine of claim 9, wherein the side rail portion of each of the pair of side rails defines a plurality of slots, and wherein each slot at least partially receives a corresponding rung from the plurality of rungs to removably couple the corresponding rung with the side rail portion.

16. The work machine of claim 10, wherein the ladder is made of sheet metal.

17. A method of manufacturing a ladder for a work machine, the method comprising:
providing a first piece of material and a second piece of material;
forming a first side rail portion of a first side rail of the ladder from the first piece of material, wherein the first side rail extends along a length of the ladder from a first end of the ladder to a second end of the ladder;
bending the first piece of material to form a first portion of the first side rail such that the first portion extends orthogonally relative to the first side rail portion, wherein the first portion extends at least partially along the length of the ladder from the first end of the ladder towards the second end of the ladder, and wherein the first portion of the first side rail is adapted to removably couple the ladder with a frame of the work machine proximal to the first end of the ladder;
bending the first piece of material to form a second portion of the first side rail such that the second portion extends at an oblique angle relative to the first side rail portion, wherein the second portion defines a free end and a coupling end, and wherein the second portion extends at least partially along the length of the ladder from the first end of the ladder towards the second end of the ladder;
bending, at least partially, the second portion of the first side rail proximal to the free end to form a rolled section at the free end of the second portion;
forming a second side rail portion of a second side rail of the ladder from the second piece of material, wherein the second side rail extends along the length of the ladder and is spaced apart from the first side rail in a direction that is orthogonal to the length of the ladder, and wherein the second side rail portion extends from the first end of the ladder to the second end of the ladder;
bending the second piece of material to form a first portion of the second side rail such that the first portion extends orthogonally relative to the second side rail portion, wherein the first portion extends at least partially along the length of the ladder from the first end of the ladder towards the second end of the ladder, and wherein the first portion of the second side rail is adapted to removably couple the ladder with the frame of the work machine proximal to the first end of the ladder;
bending the second piece of material to form a second portion of the second side rail such that the second portion extends at an oblique angle relative to the second side rail portion, wherein the second portion defines a free end and a coupling end, and wherein the second portion extends at least partially along the length of the ladder from the first end of the ladder towards the second end of the ladder;
bending, at least partially, the second portion of the second side rail proximal to the free end to form a rolled section at the free end of the second portion; and
removably coupling a plurality of rungs with each of the first side rail and the second side rail such that the plurality of rungs extend between the first side rail and the second side rail.

18. The method of claim 17 further comprising removably coupling a mounting member with each of the first side rail portion and the second side rail portion, wherein the mounting member is adapted to removably couple the ladder with the frame of the work machine.

19. The method of claim 17 further comprising:
coupling a first connector with the second portion of the first side rail such that the rolled section of the second portion of the first side rail at least partially receives the first connector, wherein the first connector is adapted to removably couple the ladder with a handrail of the work machine; and
coupling a second connector with the second portion of the second side rail such that the rolled section of the second portion of the second side rail at least partially receives the second connector, wherein the second connector is adapted to removably couple the ladder with a handrail of the work machine.

20. The method of claim 17 further comprising:
at least partially receiving, within a first slot of the first side rail portion, one end of a corresponding rung from the plurality of rungs to removably couple the corresponding rung with the first side rail portion; and
at least partially receiving, within a second slot of the second side rail portion, an opposing end of the corresponding rung from the plurality of rungs to removably couple the corresponding rung with the second side rail portion.
